(19) United States
(12) Patent Application Publication
(10) Pub. No.: US 2012/0304859 A1
(43) Pub. Date: Dec. 6, 2012

(54) PROCESS AND DEVICE FOR GAS SCRUBBING

(75) Inventors: Dieter Mihailowitsch, Geretsried (DE); Eckard Steinmetz, Dresden (DE)

(73) Assignee: LINDE AKTIENGESELLSCHAFT, Munchen (DE)

(21) Appl. No.: 13/508,841

(22) PCT Filed: Nov. 4, 2010
(86) PCT No.: PCT/EP2010/006733

§ 371 Date: Jul. 10, 2012

(30) Foreign Application Priority Data
Nov. 10, 2009 (DE) 10 2009 052 640.4

(51) Int. Cl. B01D 53/18; B01D 53/14

(52) U.S. Cl. 95/223; 261/152

(57) ABSTRACT

The invention relates to a process and a device for carrying out a gas scrubbing, in which gas is conducted from bottom to top and scrubbing medium is conducted from top to bottom through a scrubbing column (T). In the scrubbing column (T) at least two scrubbing sections (WS1 and WS2) are arranged one above the other, of which the upper is restricted downwards by a chimney tray (K). From the chimney tray (K) at least some of the scrubbing medium loaded in the upper scrubbing section (WS2) is taken off at a take-off point (A) provided in the region of the chimney tray (K) and introduced as scrubbing medium into the lower scrubbing section (WS1) at an introduction point (E) provided in the region of the lower scrubbing section (WS1). A heat-exchange appliance (6) is connected in series in the direction of flow downstream of the take-off point (A) and upstream of the introduction point (E). The flow through the heat exchanger (6) is ensured solely by the hydrostatic pressure of the scrubbing medium which is given by the height difference between the take-off point (A) and the introduction point (E). A pump is dispensed with in this case.

The invention relates to a device for carrying out a gas scrubbing, in which gas is conducted from bottom to top and scrubbing medium is conducted from top to bottom through a scrubbing column, wherein at least two scrubbing sections are arranged one above the other in the scrubbing column, of which the upper is restricted downwards by a chimney tray, from which at least some of the scrubbing medium loaded in the upper scrubbing section can be taken off at a take-off point provided in the region of the chimney tray and can be introduced as scrubbing medium into the lower scrubbing section at an introduction point provided in the region of the lower scrubbing section, wherein a heat-exchange appliance is connected in series in the direction of flow downstream of the take-off point and upstream of the introduction point, and also relates to a process for operating the device.

Such devices are used, in particular, for physical gas scrubbing stages. Physical gas scrubbing stages exploit the property of liquids of absorbing and holding in solution gaseous substances, without in this case chemically binding the gases. How well a gas is absorbed by a liquid is expressed by the solubility coefficient: the better the gas dissolves in the liquid, the greater is its solubility coefficient. The solubility coefficient is temperature-dependent and generally increases with decreasing temperature.

Therefore, the liquid scrubbing medium is frequently cooled, e.g. by heat exchange with a refrigerant, before the scrubbing, to increase the solubility coefficient.

For example, amine-containing scrubbing media are used for removing carbon dioxide (CO₂) from flue gases in order to reduce the emission into the environment of substances harmful to the climate. The carbon dioxide that is scrubbed out can be compressed, optionally, after further treatment, injected underground or fed to another use. In this manner, operation of coal-fired power stations, e.g. virtually without carbon dioxide emission is possible.

According to the prior art, a flue gas CO₂ scrubbing stage is carried out in a scrubbing column in which at least two scrubbing sections are arranged one above the other and are separated from one another by a chimney tray, wherein in the lower section the first scrubbing step proceeds and in the upper section the second scrubbing step proceeds. Such a scrubbing column has, in its lower region, an appliance for feeding the flue gas that is to be scrubbed and, at the top thereof, an appliance for take-off of the scrubbed flue gas. In addition, it has appliances for feeding unloaded scrubbing medium at the column top, for take-off of loaded scrubbing medium from the chimney tray, for feeding loaded scrubbing medium into the lower scrubbing section and for take-off of the bottom product from the bottom compartment. The loaded scrubbing medium which collects in the chimney tray is taken off from this and transported at least in part by means of a pump to a heat-exchange appliance in which it is cooled for increasing the solubility coefficient. Finally, the cooled scrubbing medium is introduced into the lower scrubbing section.

Therefore, in this known method, the flow of scrubbing medium through the heat-exchange appliance is ensured by a pump. For this purpose, in addition to the actual pump, a pump drive, a pump controller and also a liquid reservoir are necessary within the scrubbing column, which demands considerable capital and operating costs. In addition, there is the risk of operating faults owing to pump outages. Since this is generally not permissible, the pump must therefore be designed with redundancy. In addition, the expenditure for regular maintenance of the pump arrangement must be taken into account.

It is an object of the present invention, therefore, to specify a device of the type in question and also a process for operation thereof, by means of which the risk of operating faults can be substantially eliminated with significantly reduced costs.

The object in question is achieved in terms of the device according to the invention in that the take-off point is arranged far enough above the introduction point such that the hydrostatic energy alone is sufficient for flow through the heat-exchange appliance and for introducing the scrubbing medium into the lower scrubbing section.

The invention is based on the consideration of replacing the pump energy by hydrostatic energy. For this purpose, between the take-off point and the introduction point for the scrubbing medium a difference in height is established which causes a hydrostatic pressure of the scrubbing medium which is sufficient for flow through the heat-exchange appliance and for introducing the scrubbing medium into the lower scrubbing section. The motive force for the scrubbing medium is therefore no longer generated by the pump, but solely by the hydrostatic energy due to the difference in height between take-off point and introduction point. Customarily, according to the prior art, a pump is used in order firstly to be free in the positioning of the heat-exchange appliance and secondly to make possible a higher pressure drop within the heat-exchange appliance and also its piping. Surprisingly, it was found by means of the invention that, firstly, an appropriate positioning of the heat-exchange appliance may be effected without increased costs, and secondly the increased costs owing to the lower permissible pressure drop of a more expensive heat-exchange appliance are more than compensated for by the lower costs owing to the omission of the pump.

Expediently, the heat-exchange appliance is arranged outside the scrubbing column and is connected via lines firstly to the take-off point and secondly to the introduction point. The take-off point is arranged at a height above the introduction point which yields a hydrostatic energy of the scrubbing medium with which the pressure drops in the lines and in the heat-exchange appliance can be overcome. In practice, the chimney tray in the scrubbing column is constructed in such a manner that, at the take-off point of the scrubbing medium destined for the lower scrubbing section, a static liquid pressure can form which is sufficient to compensate for the pressure drops which the scrubbing medium experiences on its path from the chimney tray into the lower scrubbing section. Because of the friction losses in the lines and the pressure drops caused by the heat-exchange appliance, heights of a plurality of meters can result for the chimney trays. Preferably, the height difference between the take-off point and the introduction point is approximately 2 to approximately 8 m.

An advantageous embodiment of the invention provides that at least three separate scrubbing sections separated from one another by chimney trays are arranged in the scrubbing column, wherein the take-off point for the scrubbing medium is arranged in the region of the bottommost chimney tray and the introduction point for the scrubbing medium is arranged in the region of the bottommost scrubbing section and the heat-exchange appliance is connected in series between take-off point and introduction point. Such an embodiment can be used, e.g. advantageously for the amine scrubbing of flue gases.

Beneath these scrubbing sections, optionally a prescrubbing stage can additionally be provided. In this case, the take-off point for the scrubbing medium in the region of the bottommost chimney tray is arranged above the prescrubbing stage and the introduction point for the scrubbing medium provided in the region of the bottommost scrubbing section is arranged above the prescrubbing stage.

In principle, the invention is suitable for all gas scrubbing stages in which the loaded scrubbing medium is to be taken off from an upper scrubbing section and after a heat exchange in a heat-exchange appliance, is to be introduced into a lower scrubbing section. In particular, the invention is intended for physical gas scrubbing stages in which the scrubbing medium that is taken off is cooled in the heat-exchange appliance for increasing the solubility coefficient and introduced into the lower scrubbing section.

The invention further relates to a process for carrying out a gas scrubbing, in which gas is conducted from bottom to top and scrubbing medium is conducted from top to bottom through the scrubbing column, wherein at least two scrubbing sections are arranged one above the other in the scrubbing column, of which the upper is restricted downwards by a chimney tray, from which at least some of the scrubbing medium loaded in the upper scrubbing section is taken off, passed through a heat-exchange appliance and introduced as scrubbing medium into the lower scrubbing section.

The object in question is achieved in terms of the process in that the scrubbing medium is driven through the heat exchanger to the lower scrubbing section solely on account of the hydrostatic energy.

A preferred embodiment of the process according to the invention provides that at least some of the carbon dioxide is scrubbed out of a carbon dioxide-containing flue gas using an amine-containing scrubbing medium.

By means of the invention it is possible to dispense with the otherwise customary pump with drive, controller and reservoir volume, whereby not only the capital costs but also the operating costs can be considerably decreased. In addition, the susceptibility to faults is markedly reduced.

Hereinafter the invention is described in more detail with reference to exemplary embodiments shown schematically in the figures and in comparison with the prior art. In the drawings

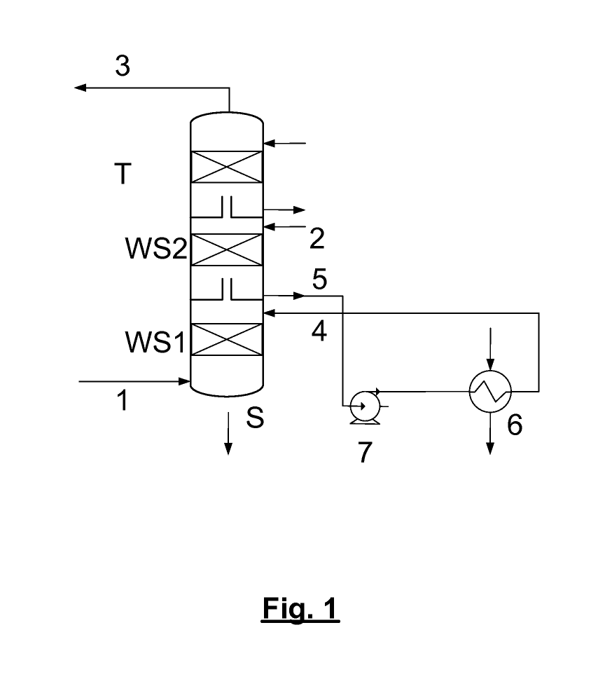

FIG. 1 shows a scrubbing column having a pump-driven intermediate cooler according to the prior art

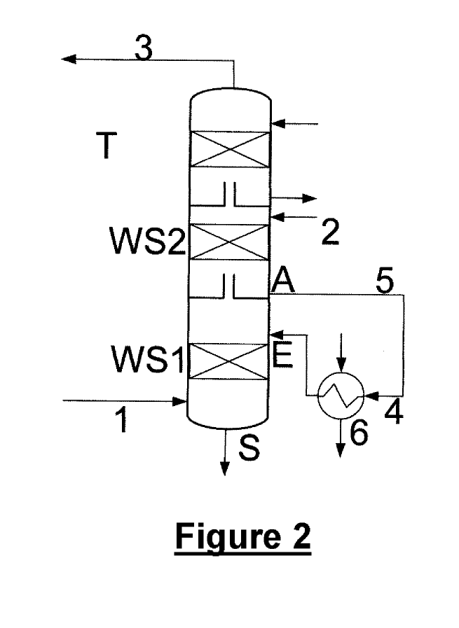

FIG. 2 shows a scrubbing column having a gravity-driven intermediate cooler

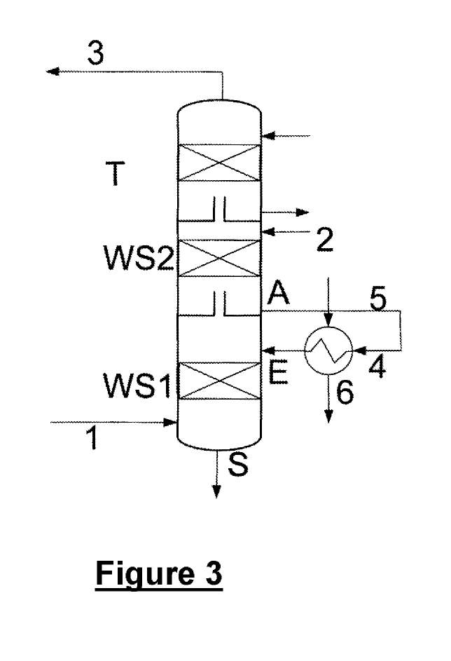

FIG. 3 shows a scrubbing column having a gravity-driven intermediate cooler arranged at an elevated level

In FIG. 1, a scrubbing column for flue gas CO₂ scrubbing of the prior art is shown in which the carbon dioxide is substantially removed from a carbon dioxide-containing flue gas which occurs, e.g., in a coal-fired power station, by means of an amine-containing scrubbing medium in a plurality of scrubbing sections. The carbon dioxide that is scrubbed out can, after an appropriate treatment which is not shown in the figure, can finally be injected underground or fed to another use, e.g. as feedstock for bioreactors (algal cultures) for fuel generation.

Via line 1, the flue gas that is to be purified is introduced into the scrubbing column T and then flows upwards through the lower scrubbing section WS1. Scrubbing medium that has already been used for gas scrubbing in the upper scrubbing section WS2 is collected in the chimney tray K which closes the scrubbing section WS2 at the bottom and is passed into the lower scrubbing section WS1 via lines 5 and 4. The scrubbing medium flows into the lower scrubbing section WS1 from top to bottom and on its pathway scrubs some of the carbon dioxide out of the flue gas that is conducted in counterflow before it is collected—again loaded with CO₂ and possibly other components—in the bottom compartment S of the scrubbing column T. The flue gas that is already in part purified flows through the chimney tray K upwards into the upper scrubbing section WS2 in which it is further purified from carbon dioxide by scrubbing medium conducted in counterflow that is introduced in regenerated form at the top of the scrubbing section WS2 via line 2. Via line 3, the purified flue gas is finally taken off from the scrubbing column T.

For increasing the solubility coefficient of the scrubbing medium, the scrubbing medium that is taken off from the scrubbing column via line 5 is cooled by heat exchange with a refrigerant in a heat exchanger 6 provided as a heat-exchange appliance customarily called an intercooler. The cooled scrubbing medium is introduced via line 4 into the lower scrubbing section WS1. The flow through the heat exchanger 6 is ensured by a pump 7.

The embodiment of the invention shown in FIG. 2 differs from the prior art shown in FIG. 1 in that the flow through the heat exchanger 6 is not ensured by a pump, but solely via the hydrostatic pressure of the scrubbing medium that is taken off via line 5 from the chimney tray K. For this purpose the take-off point A is arranged at a height above the introduction point E that causes a hydrostatic pressure sufficient for overcoming the pressure drop in lines 4 and 5 and in the heat exchanger 6. In this case, the height difference between the take-off point A and the introduction point E is, in practice, e.g. 2 to 8 m.

In FIG. 3, a variant of the exemplary embodiment shown in FIG. 2 is depicted, in which the heat exchanger 6 is arranged at an elevated level in order to reduce the pressure drops in the lines 4 and 5 and thereby the necessary hydrostatic pressure, that is to say the height difference between take-off point A and introduction point E.

1. Device for carrying out a gas scrubbing, in which gas is conducted from bottom to top and scrubbing medium is conducted from top to bottom through a scrubbing column, wherein at least two scrubbing sections (WS1, WS2) are arranged one above the other in the scrubbing column (T), of which the upper is restricted downwards by a chimney tray (K), from which at least some of the scrubbing medium loaded in the upper scrubbing section (WS2) can be taken off at a take-off point (A) provided in the region of the chimney tray (K) and can be introduced as scrubbing medium into the lower scrubbing section (WS1) at an introduction point (E) provided in the region of the lower scrubbing section (WS1), wherein a heat-exchange appliance (6) is connected in series in the direction of flow downstream of the take-off point (A) and upstream of the introduction point (E), characterized in that the take-off point (A) is arranged far enough above the introduction point (E) such that the hydrostatic energy alone is sufficient for flow through the heat-exchange appliance (6) and for introducing the scrubbing medium into the lower scrubbing section (WS1).

2. Device according to claim 1, characterized in that the heat-exchange appliance (6) is arranged outside the scrubbing column (T) and is connected via lines (4,5) firstly to the take-off point (A) and secondly to the introduction point (E), and in that the take-off point (A) is arranged at a height above the introduction point (E) which yields a hydrostatic energy of the scrubbing medium with which the pressure drops in the lines (4,5) and in the heat-exchange appliance (6) can be overcome.

3. Device according to claim 1, characterized in that, in the scrubbing column (T), a physical gas scrubbing can be carried out by means of a physical scrubbing medium that is cooled in the heat-exchange appliance (6).

4. Device according to claim 1, characterized in that at least three separate scrubbing sections separated from one another by chimney trays are arranged in the scrubbing column (T), wherein the take-off point (A) for the scrubbing medium is arranged in the region of the bottommost chimney tray (K) and the introduction point (E) for the scrubbing medium is arranged in the region of the bottommost scrubbing section (WS1) and the heat-exchange appliance (6) is connected in series between take-off point (A) and introduction point (E).

5. Process for operating a scrubbing column (T) for carrying out a gas scrubbing, in which gas is conducted from bottom to top and scrubbing medium is conducted from top to bottom through the scrubbing column (T), wherein at least two scrubbing sections (WS1, WS2) are arranged one above the other in the scrubbing column (T), of which the upper is restricted downwards by a chimney tray (K), from which at least some of the scrubbing medium loaded in the upper scrubbing section (WS2) is taken off, passed through a heat-exchange appliance (6) and introduced as scrubbing medium into the lower scrubbing section (6), characterized in that the scrubbing medium is driven through the heat exchanger (6) to the lower scrubbing section (WS1) solely on account of the hydrostatic energy.

6. Process according to claim 5, characterized in that at least some of the carbon dioxide is scrubbed out of a carbon dioxide-containing flue gas using an amine-containing scrubbing medium.
